(19) United States
(12) Patent Application Publication
(10) Pub. No.: US 2012/0290543 A1
(43) Pub. Date: Nov. 15, 2012

(54) ACCOUNTING FOR PROCESS DATA QUALITY IN PROCESS ANALYSIS

(75) Inventors: Vikram Duvvoori, Gilroy, CA (US); Ranganathan Krishnan, Bangalore (IN); Prasad A. Chodavarapu, Bangalore (IN); Ravindra S. Gajulapalli, Bangalore (IN); Rajesh Ramesh Agrawal, Chennai (IN)

(73) Assignee: HCL America Inc., Sunnyvale, CA (US)

(21) Appl. No.: 13/556,514

(22) Filed: Jul. 24, 2012

Related U.S. Application Data
(63) Continuation of application No. 12/819,020, filed on Jun. 18, 2010.

(51) Int. Cl. G06F 17/30

(52) U.S. Cl. 707/687; 707/E17.044

(57) ABSTRACT

A method and system comprising an analysis module to perform automated analysis of a process supported by a process system. The analysis is performed based on data quality information that indicates a quality of process data stored in datastores to facilitate performance of the process by consumption of the process data. The system may further include process model information defining a plurality of process activities, the automated analysis being based at least in part on the process model information. The data quality information may indicate the age, validity, completeness, integrity, consistency, and/or accuracy of the process data. The analysis may be to calculate a risk of failure of the process, or may be to diagnose a cause of process failure.

### CLAIM OF PRIORITY

This application is a continuation of and claims the benefit of priority under 35 U.S.C. §120 to U.S. patent application Ser. No. 12/819,020, entitled “ACCOUNTING FOR DATA DEPENDENCIES IN PROCESS MODELS, ANALYSIS, AND MANAGEMENT,” filed on Jun. 18, 2010, which is hereby incorporated by reference herein in its entirety.

### TECHNICAL FIELD

The present application relates generally to the technical field of methods and systems for modeling, analyzing and managing processes. An example embodiment relates to methods and systems to perform computer-assisted analysis of process models.

### BACKGROUND

Process modeling in systems engineering and software engineering relates generally to modeling or mapping a process or a number of processes in an enterprise. Such process modeling may facilitate analysis and improvement of the process, for example serving to facilitate analysis of a manufacturing process, a business process, or the like.

Process modeling may therefore be useful for process management. A process model may comprise structured information not only about the sequence and relationship of respective activities constituting a process or processes, but may also define relationships of process activities to other process elements or components, such as information technology (IT) systems, human resources, and the like. In certain embodiments, a business process model may therefore be part of a larger encompassing enterprise model. The latter may facilitate enterprise resource and/or business process analysis and management.

A process model may also be used to generate a graphical representation of process information. Visual modeling languages used to represent processes include Business Process Modeling Notation (BPMN) and the Event-driven Process Chain (EPC).

### BRIEF DESCRIPTION OF THE DRAWINGS

Some embodiments are illustrated by way of example and not limitation in the figures of the accompanying drawings in which:

FIG. 1 is a schematic block diagram of a process modeling system in the example form of an enterprise model system interfaced with an enterprise system, in accordance with an example embodiment.

FIG. 2 is a schematic block diagram of process analysis application(s) forming part of the example process analysis system.

FIG. 3A is a schematic diagram of a data structure of process model information according to an example embodiment

FIG. 3B is a high-level schematic diagram of another example system for analyzing a process model.

FIG. 4 is a high-level view of a value chain forming part of an enterprise model according to an example embodiment.

FIG. 5 is a lower-level view of the example enterprise model of FIG. 4, diagrammatically showing functional decomposition of one of the elements of the value chain.

FIG. 6 is yet a lower-level view of the enterprise model of FIG. 4, diagrammatically illustrating the key processes in one of the functions of FIG. 5.

FIG. 7 is an example of a process model with each step in the logical process model mapped to applications it is dependent upon in operation. Also shown are master data feeds upon which respective applications are data dependent.

FIG. 8A is a schematic flow chart illustrating a method of analyzing a process model in accordance with an example embodiment.

FIG. 8B is a high-level flow chart of an example method of analyzing process model information, which method may form part of the method of FIG. 8A.

FIG. 9 is a diagrammatic representation of a machine in the example form of a computer system within which a set of instructions for causing the machine to perform any one or more of the methodologies discussed herein may be executed.

### DETAILED DESCRIPTION

Example methods and systems to generate a coded process model or enterprise model and to perform automated analysis of the process model are described. In the following description, for purposes of explanation, numerous specific details are set forth in order to provide a thorough understanding of example embodiments. It will be evident, however, to one skilled in the art that the present invention may be practiced without these specific details.

According to an example embodiment, there is provided a system and method to perform analysis, using one or more processors, of a process supported by a process system, the analysis performed based at least in part on process model information.

The process model information comprises, at least: a logical process model defining a plurality of activities forming part of the process, the logical process model specifying relationships between the respective activities; information technology (IT) system dependency information indicative of dependency of respective activities on associated IT system elements, the IT system dependency information including datastore dependency information indicative of one or more datastores which may be accessed in execution of respective activities; and data dependency information indicative of dependency of process activities on data in the one or more datastores which may be accessed in execution of respective activities.

The term “process” as used herein comprises a series of activities to produce a product or to perform a service, and is to be interpreted broadly as including a process group, a sub-process, or any collection of processes. Therefore, the totality of activities and/or processes which may be performed in an enterprise may also be referred to as a process. In instances where the process model information is therefore with respect to an enterprise, such as a business enterprise, the process model information may thus be in the form of an enterprise model.

The term “data” as used herein refers to any information items that a process may depend upon or utilize and is to be interpreted broadly as including master data, reference data, transaction data, event data, analytical data, meta-data, text or binary content, and the like.

Differently defined, the process model information may be in the form of the logical process model together with operationalization data regarding various components required for operationalization of the process and on which process activities may be dependent. The logical process model may include a sequence in which activities of the process are performed; rules determining subsequent activities to be performed; service-level agreements (SLAs); key performance indicators (KPIs); and the like. The operationalization data may include human resource roles for performing respective activities; IT systems supporting respective activities; data dependency information regarding respective activities; physical infrastructure associated with respective activities, such as vehicles, machinery, and the like; and other elements associated with the process. In instances where the process model is in respect to a business enterprise, the resultant enterprise model may therefore depict, specify, or map the workings and interrelationships of all elements that make up an enterprise. Enterprise elements or process elements modeled in such an enterprise model may include a value chain, business domains/sub-domains, business functions/sub-functions, processes, activities, information/data, IT applications, IT hardware, human resources, physical assets, and any other elements relevant to the enterprise.

It is to be appreciated that the term “logical process model” refers to the depiction, specification, or mapping of a series of activities of an associated process, excluding process operationalization elements, e.g. IT system components, human resource information, and data dependency information.

By “process element” is meant any element of the process model, including IT hardware, IT applications, human resource components, datastores, physical elements, events, and the like.

The data dependency information may include data quality dependency information indicative of dependency of process activities on quality of data in the one or more datastores which may be accessed in execution of respective activities. The data quality dependency information may be in respect of at least one direct datastore which may be accessed during execution of an associated activity, and may further be in respect of at least one indirect datastore, one or more direct datastores being data flow dependent on the at least one indirect datastore, in that data may flow into the direct datastore from the indirect datastore, for instance by means of data transfers or data synchronizations between the direct and indirect datastores. The data quality dependency information may include an indication of dependency of respective activities on aging of data in at least one datastore associated with the activity.

The data dependency information may include data availability dependency information indicative of dependency of process activities on the availability of data in the one or more datastores which may be accessed in execution of respective activities. The data availability dependency information may, for instance, include data flow dependency information indicative of dependency of one or more direct datastores on associated process elements for data flow into the respective datastores. Such data flow dependency information may therefore be indicative of process elements contributing to the flow of data into one or more direct datastores, as well as dependency of respective process activities on the flow of data into the respective direct datastores. The data flow dependency information may be with respect to process elements which contribute directly or indirectly to data flow into the direct datastore, and may thus include information regarding data flow into indirect datastores.

The data availability dependency information may include data element dependency information indicative of dependency of respective activities on particular data elements in the one or more datastores which may be accessed in execution of respective activities. Such data element dependency information may thus, for example, indicate particular data elements, such as data fields, data records, or the like, on which respective activities are dependent. The data element dependency information may be in respect of dependency on a particular data element for execution of a process activity in general. Instead, or in addition, the data element dependency information may be in respect of dependency of a particular data element for execution of a process activity regarding a particular instance or instances of the process. In an invoicing activity, for example, data element dependency information may indicate that the process activity for a particular instance is dependent on the presence or availability in the associated datastore of a client account code for a client associated with the particular instance.

It is to be appreciated that datastore dependency is distinct from data dependency. Datastore dependency is concerned with whether or not a particular datastore is available and/or operational, while data dependency is concerned with the availability and/or quality of data in an operational and available datastore. In other words, data dependency relates to the availability and/or quality of data in a datastore, assuming that the datastore is fully operational. Thus, for example, the failure of a server on which a datastore is hosted, or the failure of a data link to a datastore, will be related to datastore dependency. In contrast, for example, the absence of particular required records or data fields in a datastore, even when the datastore is fully operational; the quality of data in the datastore; the failure of data transfers into the datastore; or the failure of data synchronization between the datastore and another datastore will be related to data dependency.

The system may further include data state information indicative of the quality and/or availability of data in one or more datastores which may be accessed in execution of respective activities, the process model analysis module being configured to perform analysis based at least in part on the data state information. Analysis may therefore be performed using the process model information in conjunction with the data state information.

The data state information may include data quality information indicative of data quality of data in at least one datastore forming part of the process system. The data quality information may include data aging information, data validity/accuracy/completeness/consistency/integrity information, or the like.

The data state information may include data flow history information indicative of data events related to the flow of data into the one or more datastores. The method may further comprise comparing historical data regarding performance of data events to scheduled data events, and identifying nonperformance of a particular data event as a data event failure. The data events may comprise a data transfer between two datastores. Instead, or in addition, the data events may comprise data synchronization between two datastores. The data state information may include data element information indicative of the presence for availability of particular data elements in the respective datastores.

The data state information may be in respect to at least one direct datastore which may be accessed during execution of an associated activity. Instead, or in addition, the data state information may be in respect to at least one indirect datastore, one or more direct datastores being data flow dependent on the at least one indirect datastore.

The analyzing may comprise calculating a risk of failure of the process, diagnosing a cause of failure of the process, or generating management information responsive to failure of process elements on which one or more activities are dependent, the management information being generated based on the analysis of the process model.

### Architecture

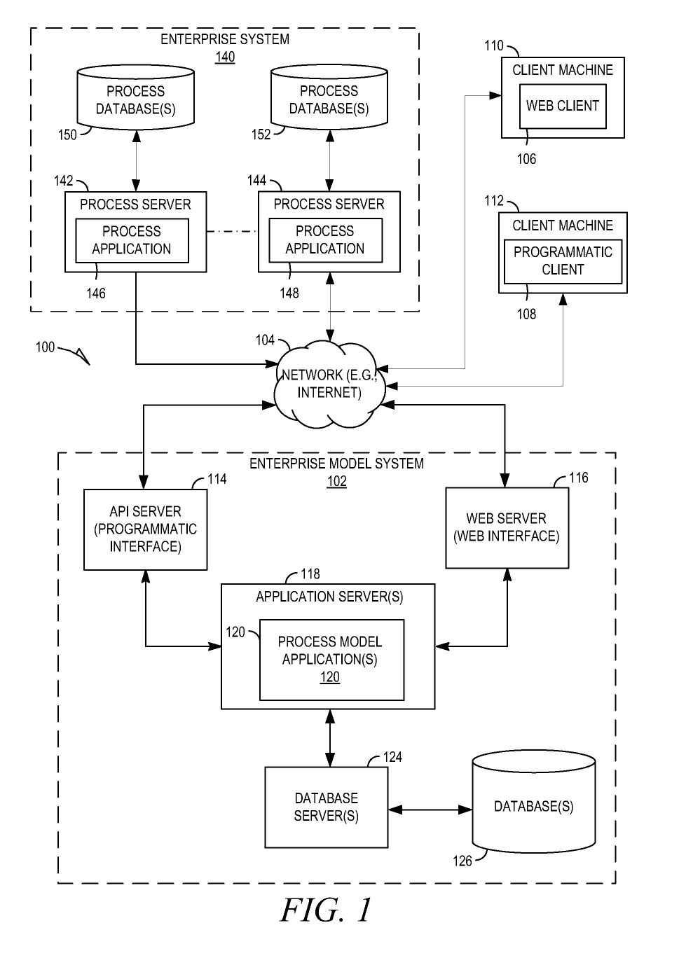

FIG. 1 is a network diagram depicting a client-server system 100, within which one example embodiment may be deployed. A networked enterprise model system 102 in the example form of a dynamic process modeling system, provides server-side functionality, via a network 104 (e.g., the Internet, a Wide Area Network (WAN), or a Local Area Network (LAN), to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

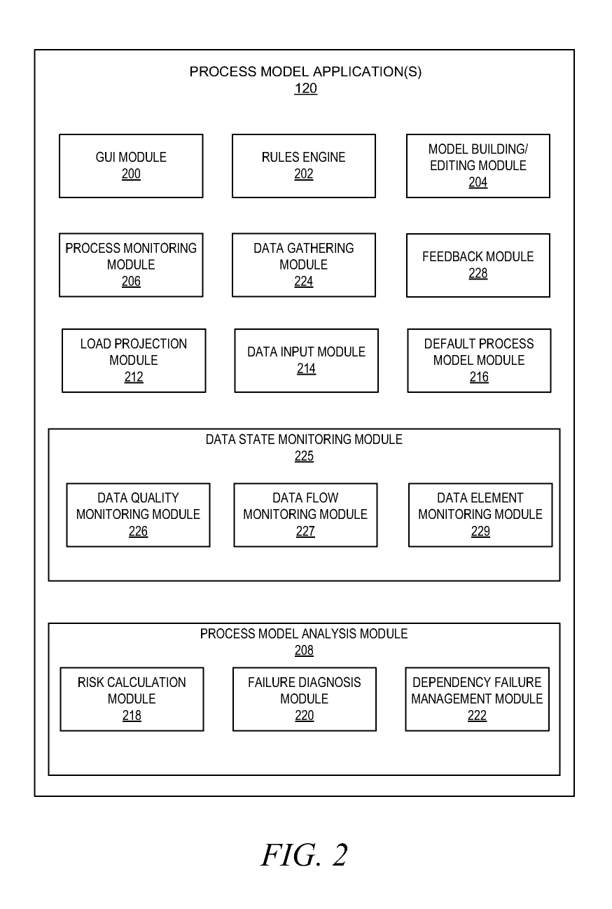

An Application Program Interface (API) server 114 and a web server 116 are coupled to, and provide programmatic and web interfaces respectively to, one or more application servers 118. The application servers 118 host one or more process model applications 120 (see FIG. 2), the process model applications, in this example, enterprise model applications. The application server(s) 118 are, in turn, shown to be coupled to one or more databases server(s) 124 that facilitate access to one or more database(s) 126.

The system 102 is also in communication with a process system which supports a process which is to be modeled by the process model application(s) 120 (e.g., business process models (BPM)). In the example embodiment, the process system is a client enterprise system, generally indicated by reference numeral 140, which supports a business enterprise. The system 102 of the example embodiment of FIG. 1 may therefore be an enterprise model system. The process model application(s) 120 may be in communication with components of an IT system of the enterprise, in particular being in communication with a number of process servers 142, 144 forming part of the IT infrastructure of the client enterprise system 140. Each of the process servers 142, 144 supports one or more process applications 146, 148, each process application 146, 148 providing functionalities employed in the performance of an associated activity or process supported by the enterprise system 140. Each process server 142, 144 may be in communication with one or more associated database(s) or process datastore(s) 150, 152, to read and/or write associated process data to the respective process datastore(s) 150, 152.

For example, process application 146 may be an accounting application, the process data in the associated process datastore(s) 150 comprising client account information, while process server 144 may be a case management application, the process data in the associated process datastore(s) 152 comprising records of respective cases processed by the enterprise system 140. It will be appreciated that the enterprise system 140 may typically comprise a greater number of process servers 142, 144 and process datastores 150, 152, but FIG. 1 shows only two such process servers 142, 144, for ease of explanation. It is further to be appreciated that communication and interfacing between respective process servers 142, 144 may occur via the network 104, while some of the process servers 142, 144 may be in direct communication.

The process model application(s) 120 may provide a number of functions and services to users that access the enterprise model system 102, for example providing analytics, diagnostic, predictive and management functionality relating to system architecture, processes, and the activities of the enterprise supported by the enterprise system 140. Respective modules for providing these functionalities are discussed in further detail with reference to FIG. 2 below. While all of the functional modules, and therefore all of the process model application(s) 120 are shown in FIG. 1 to form part of the enterprise model system 102, it will be appreciated that, in alternative embodiments, some of the functional modules or process model applications may form part of systems that are separate and distinct from the enterprise model system 102.

Further, while the system 100 shown in FIG. 1 employs a client-server architecture, the example embodiments are of course not limited to such an architecture, and could equally well find application in a distributed, or peer-to-peer, architecture system, for example. The process model application(s) 120 could also be implemented as standalone software programs, which do not necessarily have networking capabilities.

The web client 106 accesses the process model application(s) 120 via the web interface supported by the web server 116. Similarly, the programmatic client 108 accesses the various services and functions provided by the process model application(s) 120 via the programmatic interface provided by the API server 114.

### Process Model Application(S)

FIG. 2 is a block diagram illustrating multiple functional modules of the process model application(s) 120 of enterprise model system 102. Although the example modules are illustrated as forming part of a single application, it will be appreciated that the modules may be provided by a plurality of applications The modules of the application(s) 120 may be hosted on dedicated or shared server machines (not shown) that are communicatively coupled to enable communications between server machines. The modules themselves are communicatively coupled (e.g., via appropriate interfaces) to each other and to various data sources, so as to allow information to be passed between the modules or so as to allow the modules to share and access common data. The modules of the application(s) 120 may furthermore access the one or more databases 126 via the database servers 128.

The enterprise model enterprise model system 102 may therefore provide a number of modules whereby a user may build or define a process model(s) or enterprise model for the enterprise system 140 monitor the execution of activities forming part of the process, and perform automated diagnostic or predictive analysis of the process model. To this end, the application(s) 120 is shown to include at least one default process model module 216 to provide default process models. In instances where the process model is in respect to a business enterprise, the default process model module 216 may provide default business process models (BPM) which are to serve as bases for a user to define a business process model specific to the enterprise system 140. The default BPM's may be predefined by a supplier of the business process model application(s) 120 and are in respect to generic business processes relating to a variety of types of businesses or types of business activities. A user may thus, as a starting point for defining an enterprise-specific BPM, select one or more default process models which most closely approximate the business processes performed by the enterprise system 140. The default process model module 216 may typically provide default logical process models indicating a series of activities, without specific operationalization information indicating particular process elements or support elements on which the activities are dependent.

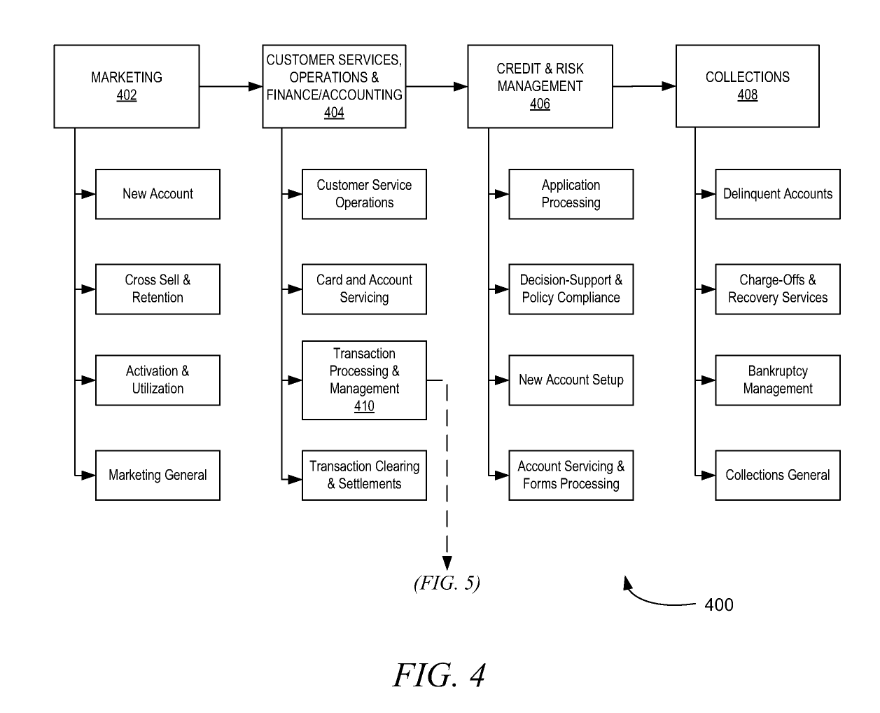

A model building/editing module 204 is provided to enable a user or administrator to define an enterprise-specific process model, either by editing, adapting, or building on a selected default enterprise model, or by building an enterprise model from scratch. The model building/editing module 204 also enables the editing of the enterprise model in response to changes in the enterprise system 140 or the associated processes. As mentioned above, such an enterprise model is a process model which may represent sequences and relationships of business processes, business process activities, as well as relationships of such business process activities to the information technology (IT) infrastructure, process applications 146, 148, and process data. An example enterprise model is described in greater detail with reference to FIGS. 4-7 below.

In this regard, IT infrastructure refers to the configuration and arrangement of hardware forming part of the enterprise system 140. IT infrastructure information may thus include the properties, statuses, configuration, and relationships of hardware components such as particular servers, machines, and/or interfaces in the enterprise system 140. The term IT system includes the IT infrastructure and software or process applications 146, 148 supported by the IT infrastructure.

The enterprise model system 102 may include a logical process model together with, on the one hand, dependency information which may include data dependency information, and, on the other hand, historical data which may include information on the state of data in respective datastores in the system. The logical process model may define a plurality of activities forming part of the process, and may define the relationship between activities, such as the sequence in which activities are performed, and/or rules determining choices between respective activities. The dependency information defines process elements which contribute to performance of respective process activities. The dependency information may include IT system dependency information, which defines IT system elements, such as software and hardware components, contributing to respective activities. The dependency information may further include human resource dependency information, which defines particular human resources, people, or personnel contributing to respective activities. The dependency information may also include, as part of the IT system dependency information, datastore dependency information that indicates the relationship between respective activities and associated datastores that are accessed during execution of the respective activities. It is to be appreciated that, with respect to a particular activity, datastore dependency information specifies the relationship between the activity and datastores which are accessed in execution of the particular activity.

The dependency information may further include data dependency information which indicates dependency of process activities on data in respective datastores which may be accessed in execution of respective activities. In particular, the data dependency may indicate dependency of the process activities on availability and/or quality of data in the respective. The data dependency information may thus include data quality dependency information and data availability dependency information. Furthermore, the data availability dependency information may include data flow dependency information which indicates dependency of respective datastores on associated process elements for data flow into the respective datastores. Data flow dependency information with respect to a particular activity may thus indicate those process elements on which datastores which are accessed during performance of that particular activity may be data flow dependent.

The term “data dependent” means that a particular process element contributes to the availability and/or quality of data in the datastore, and that failure or absence of the particular process element may affect the availability and/or quality of data in the datastore. Likewise, the term “data flow dependent” means that a particular process element contributes to the flow of data into a particular datastore, and that failure or absence of the particular process element may affect the flow of data into the particular datastore. In this regard a process element may include, for example, a data source, an IT infrastructure component, a process application, a process event, a human resources component, or the like. The term “datastore” means any repository or memory on which data is stored, and may include internal memory forming part of a device contributing to performance of activity, as well as external databases.

As used herein, “dependency,” “explicit dependency,” or “direct dependency” of an activity means that an associated process element contributes to performance of the activity, but it excludes data dependency. Consider, for example, an activity that is performed by an application which accesses a particular datastore during execution of the application, while data in the particular datastore is e.g. periodically synchronized with a master datastore. In such case, the activity will be datastore dependent on the particular datastore which is accessed during execution of the application, and will be data dependent on the master datastore, in particular being data flow dependent on the master datastore. It is to be appreciated that, in the above example, the activity will not be datastore dependent on the master datastore, so that the relationship between the activity or application and the master datastore will not form part of IT system dependency information or datastore dependency information with respect to the activity, but will be included in data dependency information with respect to the activity. In particular, the relationship between the activity or application and the master datastore may in such case form part of data flow dependency information, which may be a subset of data availability dependency information. The data availability dependency information may, in turn, be a subset of the data dependency information.

The process model application(s) 120 further includes a graphic user interface (GUI) module 200 to generate and manage an interactive GUI to display various aspects of the process model, and to permit user management of the process model. In instances where all the processes of the enterprise system 140 are defined in a process model (e.g. instances where the process model is an enterprise model), it is typically not possible to display a representation of all of the processes and/or an entire business architecture in a single view, and the GUI will allow user selection of different levels or layers of the enterprise model for viewing. Such drill-down functionality is described in greater detail below with reference to FIGS. 4-7.

A data input module 214 provides functionality to permit the input of data for use in process model analysis. Information about scheduled downtime for the process applications 146, 148 and/or scheduled downtime for IT infrastructure elements may, for example, be inputted via the data input module 214. Similarly, in an example embodiment human resource scheduling information, such as information about personnel availability, e.g. holiday calendars, may also be inputted into the enterprise model system 102. The data input module 214 may be configured for manual input of this information, and may instead or in addition provide for automatic integration of scheduling data from other databases. For example, personnel unavailability data may automatically be obtained from a Human Resources database (not shown) forming part of the enterprise system 140.

A rules engine 202 may be provided to permit the definition of metrics by which performance of business processes is to be measured. A user may thus provide, via the rules engine 202, failure definitions that specify what constitutes failure of a particular business process. In an example embodiment, the business process model may include service-level agreements (SLAs) which specify, in measurable terms, contractual service commitments describing the minimum performance criteria an associated process is required to meet. Failure to comply with the requirements of an SLA may be specified as constituting failure of the associated process. The rules engine 202 may further enable the definition of performance indicators, such as key performance indicators (KPIs), in relation to respective processes or process activities. Such performance indicators serve to provide quantifiable performance measurement of an associated process or process activity.

The process model application(s) 120 may further include a data gathering module 224 to gather and collate information regarding the performance of respective processes and/or activities. To this end, the data gathering module 224 may cooperate with monitoring applications (not shown) installed in each of the process servers 142, 144 and/or client machines (not shown) forming part of the enterprise system 140. The system 102 may thus gather and record information regarding activities performed by respective elements forming part of the enterprise system 140. A data event such as data synchronization, data collation, or data transfer between two data repositories may be logged or recorded, to facilitate tracking or monitoring of performance of the associated business activities, and to facilitate monitoring of data state information with respect to particular activities or datastores by a data state monitoring module 225, as described below. Further data which may be gathered may include error data generated in response to unscheduled unavailability of applications or infrastructure elements.

To this end, the application(s) 120 may include a process monitoring module 206 to monitor performance of the processes defined in the enterprise model. Data gathered by the data gathering module 224 may thus automatically be compared to process activities which are scheduled according to the enterprise model, thereby to identify process event failures. The process monitoring module 206 may further compile historical data regarding system failures. Such historical data may, in particular, include applications failure history, infrastructure failure history, physical infrastructure failure history, and the like. An application failure may for example include failure of a process application to execute, while an infrastructure failure may comprise unscheduled downtime of a server or unavailability of communication links between system components.

The data state monitoring module 225 may serve to monitor the state of process data associated with respective processes and/or process activities, for example monitoring data flow history, data quality information, data element information, and the like. The data state monitoring module 225 may thus include a data flow monitoring module 227 to monitor the flow of data into respective datastores. The data flow monitoring module 227 may in particular monitor the performance of data events to compile a data flow history, which may include data event failures. Data event failures may include the non-occurrence or failure of a scheduled data event such as a data transfer, data synchronization, or the like.

The data state monitoring module 225 may further include a data quality monitoring module 226 to compile data quality information indicative of the quality of data in the respective datastores, which may include monitoring data validity/accuracy/completeness/consistency/integrity and/or referential integrity of the particular datastores storing process data, and/or data aging or data staleness information. Data aging information may comprise information relating to the recency of transfer or synchronization of particular process data. Thus, for instance, synchronization of client address data in an accounting database with a client master database may result in the client address data in the accounting database being considered to be fresh, progressively increasing in age with an increase in the time since the synchronization. Process data which ages beyond a predefined threshold value may be identified as stale data. The data quality monitoring module 226 may also include data flow history information insofar as it relates to data quality. Thus, for instance, failure of a scheduled data event, such as a data synchronization event, in respect to a particular repository may result in the associated data being identified as stale.

The data state monitoring module 225 may also include a data element monitoring module 229 to monitor or compile information about data elements or the completeness of information in respective. The data element monitoring module 229 may for example compile information as to whether or not the data in a particular datastore contains all the data elements of a minimum data set for performing a particular activity in respect of a specific case. The data element monitoring module 229 may automatically compile the data element information in respect of all relevant cases, or may instead compile data element information in respect of a specified case in response to user instruction or request.

To facilitate process management, the process model application(s) 120 may include a load projection module 212 to calculate a projected load on particular processes and/or activities defined in the enterprise model. By load is meant the amount of work which is performed by a process at a particular point in time, or over a particular period. The load on a particular process or process activity may, for example, be calculated as a number of cases which is scheduled to be processed. A “case” is an instance of a process. For example, in a process for generating invoices, a particular case may refer to a specific invoice generated for a particular customer.

Load projection may be calculated with respect to a particular process step or activity, with respect to a specified process or sub-process, with respect to a process group, or with respect to the entirety of the enterprise model. The load projection module 212 may be configured to calculate the load projection based, in part, on current load information, which may be gathered by the data gathering module 224.

A process model analysis module 208 may provide for automated or computer-assisted analysis of the processes of the enterprise system 140, via analysis of the enterprise model. Analysis functionality provided by the process model analysis module 208 may include risk analysis, diagnostic analysis, and optimization. Such analysis may therefore be both predictive and retrospective in nature.

In particular, the process model analysis module 208 may include a risk calculation module 218 to perform risk analysis in order to calculate or estimate a risk of failure. In one embodiment, the risk or probability of failure may be calculated with respect to a new case event. For example, when a new case is entered into the enterprise system 140, the risk calculation module 218 may calculate the probability of failure of that case and/or may calculate the probability of failure with respect to other cases being processed by the enterprise system 140. In one embodiment the calculated risk or probability of failure may be expressed as a percentage. It is to be kept in mind that, in this regard, failure is assessed according to the failure definitions generated via the rules engine 202, which may include SLA violations. Other events in response to which the risk or probability of failure may be calculated include, for example, change in the architecture of the enterprise system 140 that affects associated processes, change in the status of associated entities, and the like.

The process model analysis module 208 may further include a failure diagnosis module 220 to identify or calculate probable causes of process failure. Thus, if a process failure is recorded, the failure diagnosis module 220 may automatically or selectively be employed to perform diagnostic analysis in order to establish a probable cause or causes of the failure. It will be appreciated that the historical data gathered, inter alia, by the data gathering module 224 may be accessed by the failure diagnosis module 220 for failure diagnosis.

In this regard, it is to be noted that the data state information, which may include, inter alia, data integrity information, data aging information, data quality information, data element information and data flow history information may form part of the historical data accessed for failure diagnosis. Furthermore, process failure may be defined in particular instances such that process failures may be caused not only by failure to provide a particular output on time, but may also result from an incorrect or inaccurate output. For example, in an invoicing process, it may not be sufficient merely to provide an invoice to a customer within a predefined period, but it is also required that the information on invoice be accurate. Sending an invoice to an incorrect address may, for example, cause a failure in the invoicing process. Failure diagnosis may in such an instance identify insufficient data quality as a cause of the failure, and may more particularly identify a specific data event failure as the probable cause of failure. In the above-mentioned invoicing example, an incorrect customer address may have resulted from a failure in a data synchronization event between a master client database and an account information database.

The process model analysis module 208 may also include a dependency failure management module 222 to provide management information responsive to dependency failure events. A dependency failure event may include a failure of any of the elements included in the enterprise model on which a particular process or process activity is dependent or is data dependent, and may therefore include process application failures, IT infrastructure failures, unscheduled unavailability of personnel, failures in data quality, data event failure, or the like. Failures in data quality may include staleness of data, inconsistency of data, and the like.

When such a failure event occurs, the dependency failure management module 222 may serve to assist in identifying appropriate responses or changes to the process, to reduce the risk of process failure. Failure forecasts or predictions may thus be presented for respective change scenarios. If, for instance, a particular process server 142 were to fail, an administrator or user may be able, with the assistance of the dependency failure management module 222, to calculate or predict the risk of failure for a number of alternative configurations of the remaining available IT infrastructure elements. Again, such dependency failure management analysis may be performed based, at least in part, on the stored data quality information and/or data dependency information.

A feedback module 228 may provide automated feedback on process failures and may incorporate such information in analysis to be performed by the process model analysis module 208. Algorithms, variables, or historical data employed by the respective modules of the process model analysis module 208 may therefore be modified in response to failure diagnosis, so that the process model analysis module 208 is adaptive, iteratively improving its predictive or prospective analysis. For example, if a process failure is due to a data quality failure, aging data of the associated process data may be retrieved and provided to the process model analysis module 208 for incorporation in statistical failure data used by the module 208 for predictive analysis.

### Data Structures

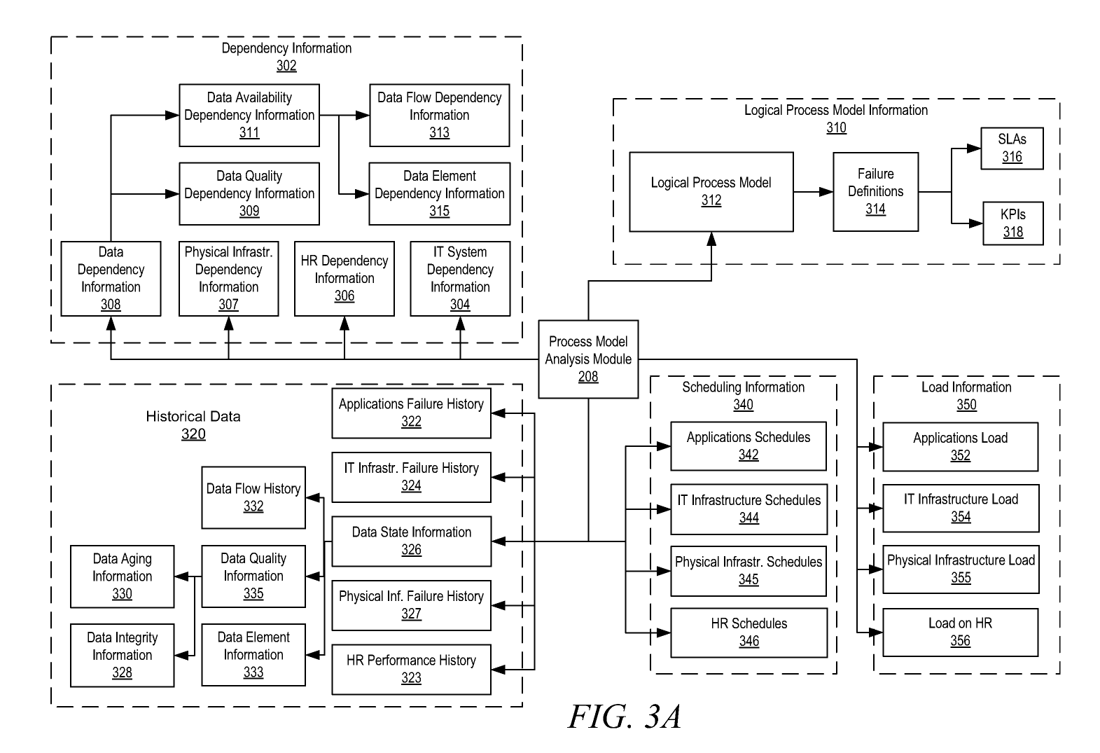

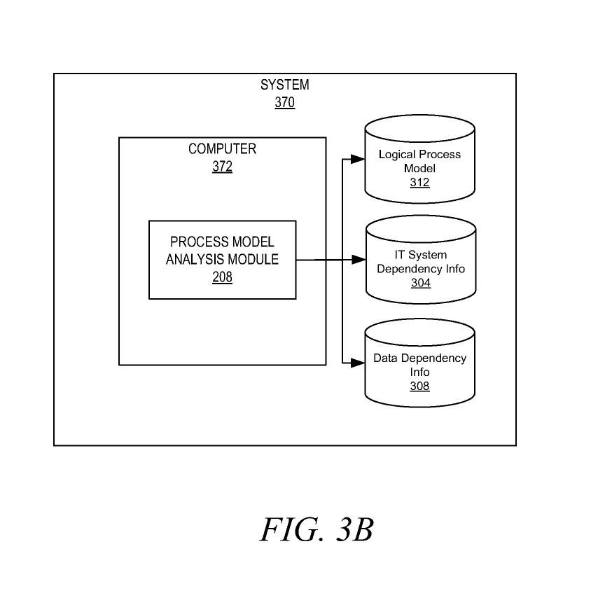

FIG. 3A is an entity-relationship diagram, illustrating various tables, data repositories, or databases that may be maintained within the databases 126 (FIG. 1), and that may be utilized by the process model application(s) 120. Thus, the databases 126 may include dependency information 302 in process dependency repositories, the dependency information 302 comprising structured information regarding dependencies of respective processes and/or process activities of the enterprise model. The dependency information 302 include IT system dependency information 304 that comprises information regarding process dependency on IT system elements of the enterprise system 140. The IT system dependency information 304 may thus include information regarding dependency of processes or activities on software such as process applications 146, 148, as well as dependency on IT infrastructure. The IT system dependency information 304 also includes datastore dependency information indicative of relationships between respective activities and datastores which are accessed in performance of the respective activities. The IT system dependency information 304 enables the generation of an interactive GUI displaying those process applications and process servers on which a selected process or process activity is dependent.

The dependency information 302 may further include human resources dependency information 306 in which is stored structured information regarding the dependency of respective processes or process activities on particular human resource components, such as people or personnel. The HR dependency information 306 may for example specify the job role or personnel department responsible for the performance of a particular process activity.

Physical infrastructure dependency information 307 may also be included in the dependency information 302 to indicate the dependency of respective process activities on physical infrastructure components. Such physical infrastructure components may include, for example, vehicles, machinery, supply-chain elements, buildings, and the like.

The dependency information 302 also includes data dependency information 308. As explained by way of example above, the data dependency information 308 may include data quality dependency information 309 and data availability dependency information 311. The data quality dependency information 309 indicates dependency of process activities on quality of data in respective datastores, such as the databases 150 and 152 (FIG. 1). The data quality dependency information 309 may thus, e.g., indicate dependency of particular process activities on the age or staleness of data in associated datastores, the data flow history of associated datastores as it relates to data quality, the referential integrity or data integrity of data in associated datastores, or the like.

The data availability dependency information 311 may comprise, at least, data flow dependency information 313 and data element dependency information 315. The data flow dependency information 313 comprises information regarding process elements, such as process applications, process servers, personnel, and/or business processes which contribute to the flow of data into respective datastores accessed during performance of associated activities/processes, and upon which such activities/processes are therefore dependent for the availability and/or quality of data. Described differently, the data flow dependency information 313 may indicate, in respect of a particular process activity, process elements upon which one or more direct datastores for the particular process activity are dependent for the flow of data into the one or more direct datastore. It is to be appreciated that explicit dependencies and datastore dependencies are defined as part of the IT system dependency information 304, while data flow dependencies are defined as part of the data dependency information 308. The provision of the data flow dependency information 313 for instance enables the process model analysis module 208 to identify or predict the effect of failure or unavailability of a particular IT infrastructure element or process application not only on processes or process activities which are directly dependent on the failed IT infrastructure element or process application, but also on processes or activities which are not directly dependent on the failed element or application, but which are dependent on the failed element or application for the flow of data into datastores which are accessed directly during execution of the process or activity.

The data element dependency information 315 may comprise information regarding dependency of respective process activities on the presence or availability of particular data elements in the associated datastores.

The databases 126 also include logical process model information 310, in this example being in respect of an enterprise model, representative of the processes and activities performed by the enterprise system 140. The logical process model information 310 includes a logical process model 312, in this example being a logical enterprise model, comprising structured data defining the processes constituting the enterprise model, and showing relationships between respective process activities constituting the respective processes. In the current example, the logical process model 312 may be a logical process model defining the sequence of process activities abstractly, without defining relationship of the activities or processes to process elements associated with operationalization of the process, which may be provided by the dependency information 302.

The logical process model 312 references failure definitions 314 which may include service-level agreements 316 and key performance indicators 318. The failure definitions 314, SLAs 316, and KPIs 318 maybe user-specified via the rules engine 202.

It will be appreciated that the logical process model information 310 and the dependency information 302 together provide process model information (or enterprise model information) defining a process architecture for the enterprise system 140, the process architecture comprising, on the one hand, the processes and activities defined by the logical process model 312, and, on the other hand, information on the operationalization of the processes and activities as defined by the dependency information 302.

The enterprise model system 102 further comprises historical data 320 indicative of past performance of processes defined in the logical process model 312, as well as being indicative of the latest state of process elements and data in respective datastores. The historical data 320 may preferably be gathered in real-time or near real-time, optionally being gathered upon performance of the respective processes or process activities. Instead, or in combination, the historical data 320 may be gathered at predefined times or intervals. Historical data 320 may include applications failure history 322 indicative of failure of process applications 146, 148, as well as IT infrastructure failure history 324 indicative of past failure of IT infrastructure elements, such as process servers 142, 144. The historical data 320 may further include physical infrastructure failure history 327 with respect to failure of physical infrastructure elements, such as vehicles, machinery, and the like. Human resource performance history 323 may also form part of the historical data 320, to provide information regarding historical performance of particular human resource components such as personnel, personnel departments, operational units, and the like.

The historical data 320 may also include data state information 326 indicative of the current or latest recorded state of data in respective datastores of the enterprise system 140. The data state information 326 may, in turn comprise, for example, data flow history 332, data quality information 335, and data element information 333. The data quality information 335 may comprise data aging information 330, as well as data validity, data accuracy, data completeness, data consistency, data integrity information and the like. FIG. 3 shows, for example that the data quality information 335 includes data integrity information 328. The data integrity information 328 may include the results of integrity checks or referential integrity checks performed on data in respective datastores. As explained above, the data flow history 332 may comprise information on the flow of data into respective datastores and may include data event failure information which indicates failure or non-performance of scheduled data events such as data transfers or data synchronization.

Although not shown in FIG. 3, the data quality information may also include data validity information which includes the results of validation checks defined by rules, reference lists and the like. For example, a telephone extension must match the known list of currently valid telephone extensions in an office. Data accuracy information may form part of the data quality information 335 and may include information on granularity to which data is captured. Numerical precision and date-time granularity are examples of data accuracy information. The data quality information 335 may further include data completeness information. The data completeness information may include the results of completeness checks defined by rules. For example, an address may be considered incomplete unless all of door number, street name, city and zip code are available. The data quality information 335 may yet further include data consistency information which may include the results of consistency checks defined by rules, lookup tables and the like. For example, zip code, city and state information in an address need to be consistent with each other.

In addition, the data element information 333 may include information regarding the presence or availability of data elements in respective datastores. Thus, for instance, if a process activity is dependent on the availability or presence of a particular data field in a direct datastore associated with that activity, but the particular data field is to be inputted directly into the datastore by a user, as opposed to flowing into the direct datastore from an indirect or source datastore, the absence of that particular data field would not necessarily be indicated by the data flow history 322 or the data quality information 335, but may be indicated by the data element information 333.

Scheduling information 340 may be provided to facilitate risk analysis or predictive analysis. The scheduling information may include: applications downtime schedules 342 indicating scheduled unavailability or downtime of process applications 146, 148; IT infrastructure downtime schedules 344 indicating scheduled unavailability of IT infrastructure elements or components, such as process servers 142, 144; physical infrastructure schedules 345 indicating scheduled availability of physical infrastructure elements, and human resource schedules 346, which may include holiday calendars or personnel unavailability schedules, to indicate when personnel, people, or other human resource components supporting the process are scheduled for unavailability.

The databases 126 may furthermore include load information 350 regarding a current and a projected load on respective elements in the process. In particular, the load information 350 may include information on applications load 352 indicative of current and projected load on process applications 146, 148, IT infrastructure load 354 indicative of current and projected loads on the IT infrastructure the enterprise system 140, physical infrastructure load 355 indicative of current and projected loads on physical infrastructure elements, and information regarding current and projected load on human resources 356. Provision of the load information 350 facilitates analysis of the business process model, and may be particularly useful in load balancing management analysis.

As illustrated in FIG. 3A, the process model analysis module 208 may access the logical process model information 310, the dependency information 302, the historical data 320, the scheduling information 340, and the load information 350 during process analysis.

FIG. 3B is a high-level entity relationship diagram of another example configuration of an enterprise model system 370. The system 370 may include a computer 372 which may include a process model analysis module 208 to perform analysis of an associated process based on process model information. Like numerals indicate like elements in FIG. 3A and in FIG. 3B.

The system 370 includes a number of databases to store the process model information, in particular comprising a logical process model 312, IT system dependency information 304, and data dependency information 308. It is to be noted that these databases are illustrated as separate entities, but that process model information can instead be stored in a single database, or in a greater number of dispersed databases, while the process model information may be stored either internally in the computer 372, or may be stored externally.

### GUIs

The concepts described above will now be further explained by way of example with reference to extracts from example GUIs that may be generated by the GUI module 200 according to an example embodiment. In FIG. 4, reference numeral 400 generally indicates an example graphical representation of a value chain diagram providing an overview of an example process defined by an enterprise model. The value chain represents the chain of business activities that generate value for an enterprise. The example value chain diagram 400 is with respect to a business which provides credit card services to customers. The value chain diagram 400 represents a highest level of the enterprise model and comprises, at the highest level, a series of organizational units. In this example, the value chain diagram 400 comprises the organizational units of Marketing 402; Customer Services, Operations and Finance/Accounting 404; Credit and Risk Management 406; and Collections 408.

It is to be noted that, at the highest level of the value chain, different enterprises in a particular industry or field of business may be somewhat similar. For example, all computer chip manufacturing firms may have a similar sequence of elements, such as fabrication. However, the enterprise model includes further levels which indicate the organization of the particular enterprise, and in such low levels there may be great differences between respective enterprises in the same field. The particular organization of an enterprise may be influenced by the scale of operations, the history of the enterprise, and a variety of other factors. For instance, two cable TV companies operating in adjacent markets and offering near identical products may be completely different in their organization at lower levels. In other examples, the value chain diagram may decompose the enterprise process, at a high level, according to business domains. In this regard, “business domain” is understood as a particular line of business. For example, in a financial services organization, domains can include Deposits, Loans, Investments, and Insurance. Such domains can be further decomposed in sub-domains. A business domain of Loans can for instance be comprised of Corporate and Personal sub-domains.

As illustrated in FIG. 4, the value chain diagram 400 specifies the functional decomposition of each of the organizational units 402 to 408 in respective series of functions or processes. Thus, for example, the organizational unit of customer services, operations and finance/accounting 404 is comprised of a series of functions or processes. A user can view further organizational details or functional decomposition of each of the functional processes constituting the organizational unit 404, by selecting the associated function or process in the GUI. Organizational units may thus be categorized by the function they perform. It is to be noted that functions may be specific to a business domain/sub-domain, or may be shared across domains/sub-domains. For example, recruiting and other human resource functions may be shared functions, while, for instance, warehouse operations may be specific to a sales and distribution area of a large retailer.

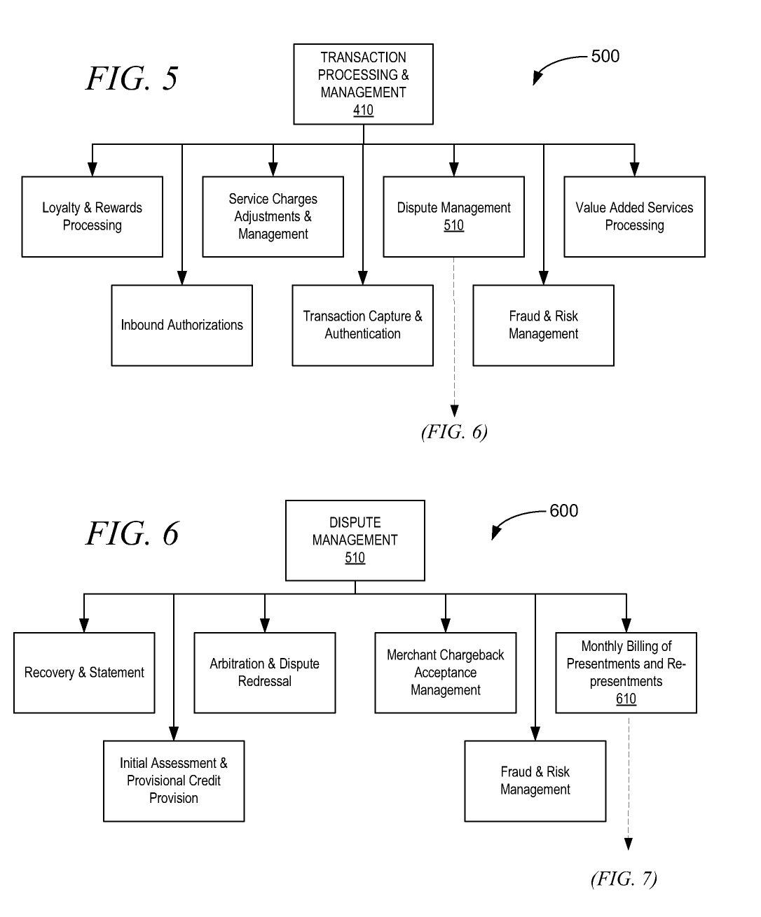

In FIG. 5, reference numeral 500 generally indicates functional decomposition of the function of Transaction Processing and Management 410, specifying a series of sub-functions which includes Dispute Management 510. The diagram 500 of FIG. 5 is thus a lower-level view of one of the functions forming part of the diagram 400 of FIG. 4, and it will be appreciated that each of the functions shown in FIG. 4 may similarly be viewed at a lower-level, or in greater magnification.

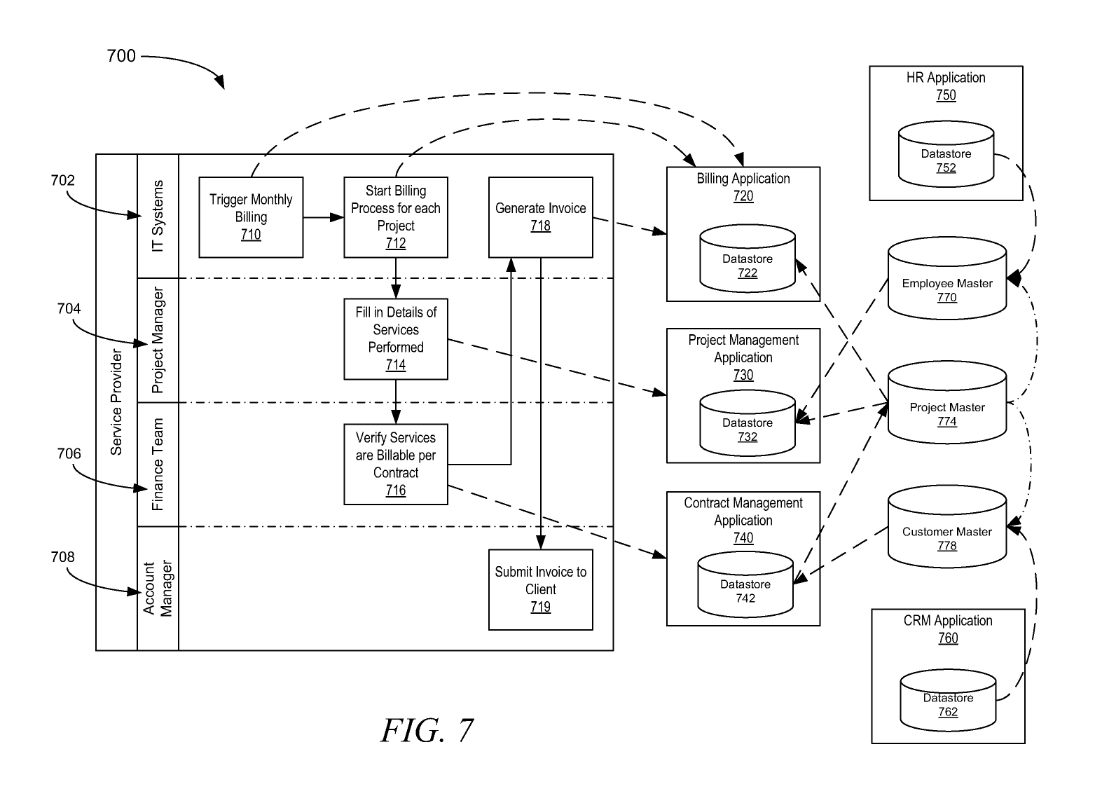

Likewise, diagram 600 in FIG. 6 shows yet further functional decomposition of the sub-function of Dispute Management 510, which comprises a series of processes forming part of the Dispute Management 510 sub-function. One of these processes is Monthly Billing of Presentments and Re-Presentments 610. A user can select any one of the processes of FIG. 6, to view a process model specifying a series of activities comprising of the process, as well as dependency information of the process activities. A GUI representative of such an example process model for the process of Monthly Billing of Presentments and Re-Presentments 610 is generally indicated by reference numeral 700 in FIG. 7. It is to be appreciated that the user may thus drill down to a specific process model, as exemplified by the various levels of the enterprise model illustrated in FIGS. 4-7. The number of levels of the enterprise model may vary depending on the complexity of the enterprise.

The process model shown in GUI 700 may include a logical process model indicating a sequence of activities 710-718. Human resource dependency information is indicated in the GUI 700 by location of blocks representing the activities 710-719 in one of a number of bands or “swim lanes” 702-708. IT system dependency is, at least partly, shown by dashed lines in FIG. 7 illustrating dependency of respective activities 710-719 on associated applications and/or datastores. In this example, the activities 710-719 are not defined in greater detail, but in other examples, some of the activities may be defined in greater detail, for instance as a series of actions such as key strokes needed to perform the activity.

The illustrated IT system components include a billing application 720 with associated datastore 722. The datastore 722 is a data repository used by the billing application 720. The billing application's datastore 722 is provided with project data accessed in performing associated activities through a data feed from a project master datastore 774.

A project management application 730 has an associated datastore 732 which is provided with project data from the project master datastore 774 and is provided with employee data from an employee master datastore 770. The IT system components on which the process is dependent further includes a contract management application 740 having a datastore 742 which is provided with customer data through a data feed from a customer master datastore 778. The contract management application 740 in turn populates the project master datastore 774, from which data is fed to the billing application 720 and the project management application 730.

The employee master datastore 770 is populated by a human resources application 750 having an associated datastore 702. Likewise, the customer master datastore 778 may be populated by the customer relations management (CRM) application 760 having an associated datastore 762. The project master datastore 774 may, in turn, refer to data in the employee master datastore 770 for employee identification, and to data in the customer master datastore 778 for custom identification, as indicated by the chain dotted lines in FIG. 7 connecting the project master datastore 774 with the customer master datastore 778 and the employee master datastore 770.

It is to be noted that the above-described relationships between applications and the respective datastores, as indicated by dashed lines in FIG. 7, are included in the IT system dependency information 304 and the data dependency information 308, in particular the data flow dependency information 313 (FIG. 3A). Those relationships indicated by chain dotted lines, which are not associated with the flow of data from one datastore to another, may form part of the data quality dependency information 309. The distinction between data dependencies and other dependencies is further expanded upon in the following description of the process model represented in GUI 700.

The example process is initiated by an activity to trigger monthly billing 710. This activity is performed automatically by the IT systems, as indicated by its being located in the IT systems band 702. The trigger activity 710 is executed by billing application 720, accessing datastore 722 during execution. Therefore, the trigger activity 710 has an IT system dependency on billing application 720 and is datastore dependent on datastore 722, datastore 722 being a direct datastore with respect to the trigger activity 710. However, datastore 722 is dependent on the project master datastore 774 for data flow into the datastore 722, and the trigger activity 710 is thus data flow dependent on the project master datastore 774. It is to be appreciated that the trigger activity 710 is not datastore dependent on the project master datastore 774, as the data in the project master datastore 774 is not accessed during performance of the trigger activity 710.

It is further to be appreciated that data flow dependency is not limited to process elements which contribute directly to the flow of data into (and therefore data availability or data quality) in a datastore which is accessed during performance of the associated activity, but extends to process elements which contribute indirectly to the data availability and/or quality of the datastore on which the activity is dependent. Therefore, trigger activity 710 is data flow dependent not only on project master datastore 774, but also on contract management application 740 and its associated datastore 742, customer master datastore 778, and CRM application 760 and its associated datastore 762.

Additionally, the trigger activity 710 is data quality dependent and data element dependent on data in datastore 722. Data quality information 335 and data element information 333 (FIG. 3A) with respect to datastore 722 may therefore, for instance, be used in analyzing a risk of failure of the trigger activity 710. An activity may also be data quality dependent and data element dependent on indirect datastores, so that data quality information 335 and data element information 333 with respect to indirect datastores 774, 742, 778, and 762 may thus also be considered in diagnostic or predictive analysis. It will be appreciated that these various dependencies are defined in the data dependency information 308 (FIG. 3A) and may be used in combination with data state information 326 for such analysis.

The datastore 722 on which the trigger activity 710 is datastore dependent thus directly contributes to performance of the activity 710, as access to the datastore 722 is a prerequisite for performance of the trigger activity 710. If the datastore 722 is inoperable, inaccessible, or unavailable, the trigger activity could not be performed for any case or project. If however, the project master datastore 774 is unavailable or has failed, the trigger activity 710 can still be performed for at least a number of projects or cases. However, in such case, periodic synchronization or updating of data from the project master datastore 774 to the datastore 722 might not occur, so that the trigger activity 710 may be performed based on stale or inaccurate data in the datastore 722. This might, for example result in the triggering of a billing process in respect to a project which has been canceled after failure of the project master datastore 774, or may cause the omission to trigger billing of projects which were generated after failure of the project master datastore 774.

In the example GUI of FIG. 7, only dependency information on applications, datastores, and human resources components are shown, but it will be appreciated that the dependency on other process components, such as client machines, servers, communication links, may also be depicted in other embodiments. Therefore, it may for example be depicted in other embodiments that the trigger activity 710 is data flow dependent on respective IT infrastructure elements supporting the applications and/or datastores on which the activity is data flow dependent. The same may apply to other forms of data dependency. The trigger activity 710 may thus for instance be data flow dependent on a server on which the contract management application 740 is executed, and may be data flow dependent on a communication link between the contract management application 740 and the project master datastore 774.

The process further includes the step activity of starting a billing process for each project, at block 712. As the activity 712 is also executed by the billing application 720, the datastore dependency and data dependency of activity 712 are similar to that of activity 710.

The next activity in sequence is to fill in details of services performed, at block 714. This activity is to be performed by a project manager, as indicated by location of the block 714 in the project manager band 704. The activity 714 is dependent on the project management application 730, and is therefore datastore dependent on datastore 732. In addition, the activity 714 is data flow dependent on at least the project master datastore 774, the employee master datastore 770, the human resources application 750, datastore 752, contract management application 740, datastore 742, customer master datastore 778, customer relations management application 760, and datastore 762.

Thereafter, the process comprises the activity of verifying that services are billable according to contract, at block 716. This activity is dependent on the human resource component of the finance team, indicated by reference numeral 706 in FIG. 7. The activity 716 is dependent on the contract management application 740, therefore being datastore dependent on datastore 742. The data dependency information 308 (FIG. 3A) with respect to the activity 716 may include data quality dependency information 309 and data element dependency information 315 regarding data in the datastore 742. However, the activity 716 is data flow dependent on those process elements which contribute to data flow into the datastore 742, therefore being data flow dependent on customer master datastore 778, CRM application 760, and datastore 762.

After verification that services are billable, at block 716, the process model includes an activity for generating an invoice, at block 718. The activity 718 is dependent on the billing application 720 and therefore has identical datastore dependencies and data dependencies as is the case with activities 710 and 712. Finally, invoices are submitted to the client, at block 719, by an account manager indicated by the associated band 708 in FIG. 7.

### Flowcharts

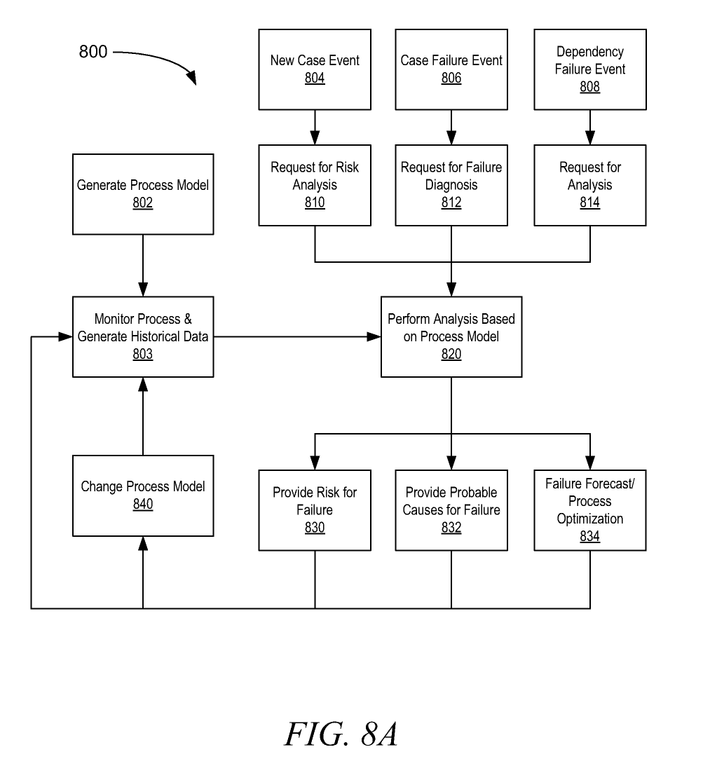

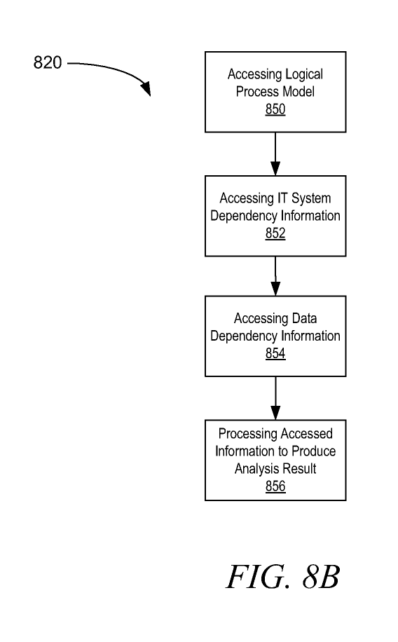

An exemplary method will now be described with reference to FIG. 8A, in which reference numeral 800 generally indicates a flowchart illustrating a sequence of steps in the method. First, a user may generate a process model, at block 802, such as, for example, the process model depicted by the GUI 700 of FIG. 7. The process model may be generated by use of the default process model module 216 and model building/editing module 204 (FIG. 2). By use of these modules, the user may thus define logical process model information 310 (FIG. 3A) and dependency information 302, including IT system dependency information 304, HR dependency information 306, physical infrastructure dependency information 307, and data dependency information 308. Scheduling information 340 may also be inserted via the data input module 214 (FIG. 2), while the rules engine 202 may be used to define failure definitions 314 (FIG. 3A).

Once the process is executed in practice, the data gathering module 224 may monitor the process and gather data, at block 803, for use in generating historical data 320 (FIG. 3A). Data gathered in this manner may thus be processed to record applications failure history 322, IT infrastructure failure history 324, and physical infrastructure failure history 327.

In addition, data state information 326 may be generated by the data state monitoring module 225 (FIG. 2). For example, the data quality monitoring module 226 forming part of the data state monitoring module 225 may, with reference to the example FIG. 7, monitor when last the datastore 722 of the billing application 720 was synchronized with the project master datastore 774. If the time since the last synchronization is more than a predetermined period, for instance a month, it may be determined that the data in the datastore 722 is stale. It will be appreciated that the synchronization interval to determine staleness of data may vary in different enterprises or functions. In another embodiment, scheduled synchronization between the project master datastore 774 and the billing application datastore 722 may be included as a data event in the data flow dependency information 313 (FIG. 3A), and the data flow monitoring module 227 forming part of the data state monitoring module 225 may monitor performance of this data event at scheduling. In this example, the data event is the synchronization between a source datastore or indirect datastore in the form of the project master datastore 774 and a direct datastore in the form of billing application datastore 722. In the event of nonperformance of the data event, the data flow monitoring module 227 may record a data event failure as part of the data flow history 332, upon which data quality calculations may be based.

The data element monitoring module 229 forming part of the data state monitoring module 225 may also perform data element monitoring or data completeness checks to generate data element information 333 (FIG. 3A). For example, data in the billing application datastore 722 or the project master datastore 774 may be submitted to data completeness checks to determine whether or not information for each project is complete, e.g. by determining whether or not each of a predefined minimum set of data elements or data fields are present in the respective datastores. Such data element monitoring or checking may be performed in respect of all projects or cases, in respect of a selected subset of projects or cases, or in respect of a particular specified project or case. Data in respect of each project or case may for instance be required to identify at least a project manager and an account manager. The data state monitoring module 225 may also perform data integrity checks and/or referential integrity checks, such as, for example, checking whether or not project managers listed in respective project records in the project master datastore 774 are still employees, as indicated by the employee master datastore 770.

Other data integrity checks may include determining whether not the information for each project or case is accurate and consistent. For example, information in the employee master datastore 770, the project master datastore 774, and the customer master datastore 778 may be correlated to ensure that, for each record, a customer's geography matches the geography of the associated account manager, a project manager's location matches the location where services are executed, or the like.

In response to the occurrence of a new case event, at block 804, risk analysis may be initiated automatically or upon user request, at block 810. Such a new case event may, for example, be when a new case created. In response to such a request for analysis, risk analysis is performed, at block 820, by the process model analysis module 208 (FIG. 2).

An example method of analysis will now be briefly discussed with reference to FIG. 8B, before returning to the method of FIG. 8A. FIG. 8B thus schematically illustrates an example method 820 of performing analysis of the process model. The method may comprise accessing logical process model information 310 (FIGS. 3A and 3B), at block 850, accessing IT system dependency information 304, at block 852, accessing data dependency information 308, at block 854, and processing the accessed information to produce an analysis result, at block 856.

The risk analysis may thus process the logical process model information 310 (FIG. 3A), the dependency information 302 (including data dependency information 308), the historical data 320 (including data state information 326), scheduling information 340, and load information 350, to calculate or predict a probability or risk of failure of the particular case or project. If, for example, the HR Schedules 346 indicate that the one of the human resource components, such as the project manager 704 (FIG. 7), is unavailable in an invoicing period, the probability or risk of failure of the process 700 may approximate 100%. Likewise, unavailability of the billing application 720 may indicate a similarly high risk of failure for the billing process 700. Risk of failure may also increase with a decrease in data quality, or due to failure of process components on which one of the activities is data flow dependent. For example, the calculated risk of failure of the process 700 may be higher if the data in the billing application datastore 722 has not been synchronized with the project master datastore for more than a month, than if synchronization occurred less than a week before. To this end, the feedback module 228, may record data quality information at the time of data failures, to improve predictive analysis of future process failures due to insufficient data quality. Returning to FIG. 8B, the calculated risk of failure may be provided to the user, at block 830, optionally expressed as a percentage probability of failure.

Process model analysis may also be performed upon failure of the process. For example, in response to a failure of the process, at block 806, the user may submit a request, at block 812, to diagnose the cause of failure. In this instance, analysis is performed, at block 820, based on the process model to determine probable causes of the failure. Results of such analysis are provided to the user at block 832.

Furthermore, a user may require computer-assisted analysis of the process model in response to a dependency failure event, at block 808. In such case, a request for analysis, at block 814, may specify the particular process element which has failed and in response to which adaptation of the process is desired. The results of the analysis performed at block 820 may in such case be presented to the user, at block 834, as a failure forecast for a plurality of alternative process configurations, and/or may comprise management information with respect to process optimization. The process, and therefore the process model, may be changed or altered, at block 840, after which monitoring and data gathering with respect to the performed process continues.

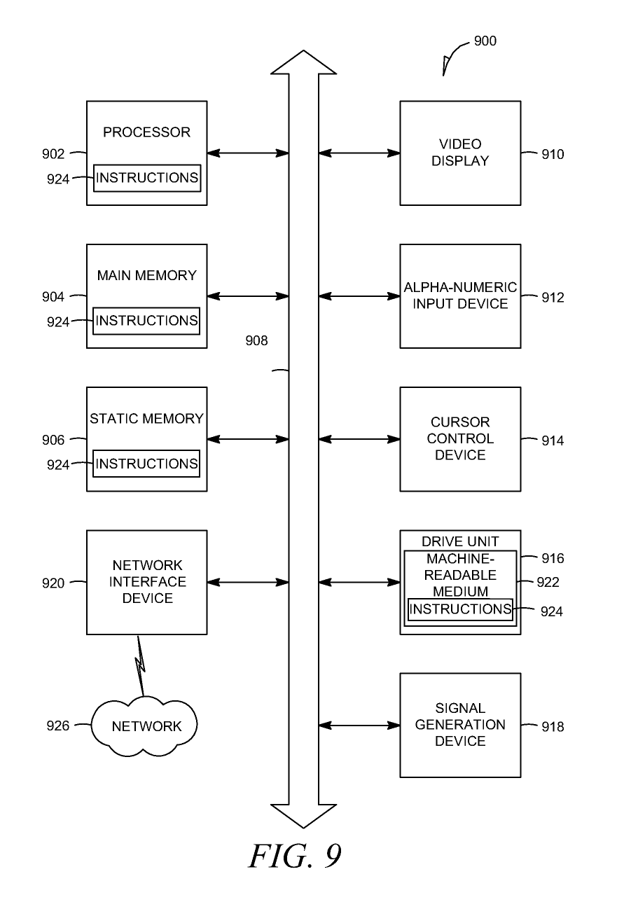

FIG. 9 shows a diagrammatic representation of machine in the example form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU) a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a cursor control device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions (e.g., software 924) embodying any one or more of the methodologies or functions described herein. The software 924 may also reside, completely or at least partially, within the main memory 904 and/or within the processor 902 during execution thereof by the computer system 900, the main memory 904 and the processor 902 also constituting machine-readable media.

The software 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to perform analysis of a process supported by a process system have been described. Although the present invention has been described with reference to specific example embodiments, it will be evident that various modifications and changes may be made to these embodiments without departing from the broader spirit and scope of method and/or system. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
one or more memories storing data quality information that indicates a quality of process data stored in one or more datastores to facilitate performance of a process by consumption of the process data by one or more information technology (IT) system elements of an IT system to perform the process; and
a computer including an analysis module to perform automated analysis to produce an analysis result with respect to performance of the process, the automated analysis being based at least in part on the data quality information.

2. The system of claim 1, further comprising process model information stored on the one or more memories, the process model information indicating a plurality of process activities comprising the process or part thereof, and the process model information specifying at least a logical sequence of the plurality of process activities, the analysis module being configured to perform the automated analysis based at least in part on the process model information.

3. The system of claim 2, wherein the process model information includes data quality dependency information indicative of dependency of respective process activities of the plurality of process activities on quality of data in at least one datastore associated with the respective process activity.

4. The system of claim 3, wherein the data quality dependency information includes an indication of dependency of respective process activities on data age in the at least one datastore associated with the respective process activity, the data quality information including data aging information with respect to data in the at least one datastore.

5. The system of claim 4, wherein the data aging information comprises information indicative of the recency of transfer and/or synchronization of data in the respective datastore.

6. The system of claim 3, wherein the data quality dependency information includes an indication of dependency of respective process activities on data accuracy in the at least one datastore associated with the respective process activity, the data quality information including data accuracy information with respect to data in the at least one datastore.

7. The system of claim 6, wherein the data accuracy information includes information on a granularity to which data in a respective store is captured.

8. The system of claim 3, wherein the data quality dependency information includes an indication of dependency of respective process activities on data completeness in the at least one datastore associated with the respective process activity, the data quality information including data completeness information with respect to data in the at least one datastore.

9. The system of claim 8, wherein the data completeness information comprises results of automated completeness checks to check completeness of respective data records.

10. The system of claim 3, wherein the data quality dependency information includes an indication of dependency of respective process activities on data validity in the at least one datastore associated with the respective process activity, the data quality information including data validity information with respect to data in the at least one datastore.

11. The system of claim 3, wherein the data quality dependency information includes an indication of dependency of respective process activities on data consistency information, the data quality information including data consistency information with respect to data in the at least one datastore.

12. The system of claim 11, wherein the data consistency information comprises results of an automated consistency check to check that zip code, city, and/or state information data are consistent with each other for respective addresses indicated by data in the at least one datastore.

13. The system of claim 3, in which the data quality dependency information is in respect to at least one direct datastore which may be accessed by the one or more IT system elements during execution of an associated process activity, and is further in respect to at least one indirect datastore, one or more direct datastores being data flow dependent on the at least one indirect datastore.

14. The system of claim 1, wherein the analysis module is configured to calculate a risk of failure of the process based at least in part on the data quality information.

15. The system of claim 1, wherein the analysis module is configured to diagnose a cause of failure of the process based at least in part on the data quality information.

16. A method comprising:
retrieving data quality information that indicates a quality of process data stored in one or more datastores to facilitate performance of a process by consumption of the process data by one or more information technology (IT) system elements of an IT system to perform the process; and
performing automated analysis to produce an analysis result with respect to performance of the process, the automated analysis being based at least in part on the data quality information.

17. The method of claim 16, further comprising the operation of accessing process model information stored on one or more memories, the process model information indicating a plurality of process activities comprising the process or part thereof, and the process model information specifying at least a logical sequence of the plurality of process activities, the automated analysis being based at least in part on the process model information.

18. The method of claim 17, wherein the process model information includes data quality dependency information indicative of dependency of respective process activities of the plurality of process activities on quality of data in at least one datastore associated with the respective process activity.

19. The method of claim 18, wherein the data quality dependency information includes an indication of dependency of respective process activities on data age in the at least one datastore associated with the respective process activity, the data quality information including data aging information with respect to data in the at least one datastore.

20. The method of claim 19, wherein the data aging information comprises information indicative of the recency of transfer and/or synchronization of data in the respective datastore.

21. The method of claim 18, wherein the data quality dependency information includes an indication of dependency of respective process activities on data accuracy in the at least one datastore associated with the respective process activity, the data quality information including data accuracy information with respect to data in the at least one datastore.

22. The method of claim 21, wherein the data accuracy information includes information on a granularity to which data in a respective store is captured.

23. The method of claim 18, wherein the data quality dependency information includes an indication of dependency of respective process activities on data completeness in the at least one datastore associated with the respective process activity, the data quality information including data completeness information with respect to data in the at least one datastore.

24. The method of claim 23, wherein the data completeness information comprises results of automated completeness checks to check completeness of respective data records.

25. The method of claim 18, wherein the data quality dependency information includes an indication of dependency of respective process activities on data validity in the at least one datastore associated with the respective process activity, the data quality information including data validity information with respect to data in the at least one datastore.

26. The method of claim 18, wherein the data quality dependency information includes an indication of dependency of respective process activities on data consistency information, the data quality information including data consistency information with respect to data in the at least one datastore.

27. The method of claim 26, wherein the data consistency information comprises results of an automated consistency check to check that zip code, city, and/or state information data for respective addresses indicated by data in the at least one datastore are consistent with each other.

28. The method of claim 18, in which the data quality dependency information is in respect to at least one direct datastore which may be accessed by the one or more IT system elements during execution of an associated process activity, and is further in respect to at least one indirect datastore, one or more direct datastores being data flow dependent on the at least one indirect datastore.

29. The method of claim 16, wherein the automated analysis comprises calculating a risk of failure of the process based at least in part on the data quality information.

30. The method of claim 16, wherein the automated analysis comprises diagnosing a cause of failure of the process based at least in part on the data quality information.

31. A non-transitory machine-readable storage medium storing instructions which, when performed by a machine, cause the machine to:
retrieve data quality information that indicates a quality of process data stored in one or more datastores to facilitate performance of a process by consumption of the process data by one or more information technology (IT) system elements of an IT system to perform the process; and
perform automated analysis to produce an analysis result with respect to performance of the process, the automated analysis being based at least in part on the data quality information.

32. A system comprising:
means for retrieving data quality information that indicates a quality of process data stored in one or more datastores to facilitate performance of a process by consumption of the process data by one or more information technology (IT) system elements of an IT system to perform the process; and
means for performing automated analysis to produce an analysis result with respect to performance of the process, the automated analysis being based at least in part on the data quality information.
